(19) United States
(12) Patent Application Publication
(10) Pub. No.: US 2006/0219774 A1
(43) Pub. Date: Oct. 5, 2006

(54) Network support for credit card receipt reconciliation

(76) Inventors: David S. Benco, Winfield, IL (US); Sanjeev Mahajan, Naperville, IL (US); Baoling S. Sheen, Naperville, IL (US); Sandra L. True, St. Charles, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/094,098

(22) Filed: Mar. 30, 2005

(51) Int. Cl. G06K 5/00; G06Q 20/00; G06K 15/00; H04Q 7/38

(52) U.S. Cl. 235/380; 235/383; 705/16; 455/414.1

(57) ABSTRACT

An apparatus in one example has: a telecommunications network having at least a receipt database; a mobile terminal having predetermined wireless communication functionality, the mobile terminal operative coupled to the telecommunications network; and a point of sale terminal wirelessly connectable to the mobile terminal.

### TECHNICAL FIELD

The invention relates generally to telecommunication networks, and more particularly to a telecommunication network that assists in reconciling credit card receipts.

### BACKGROUND

Point of sale (POS) is a concept used in many phases of business. POS may include all display and merchandising methods used to enable transactions. Point of Sale products refers to both the hardware and software that essentially helps run a business. The POS can refer to: cash register systems, cash registers, point of sale terminals, POS receipt printers, POS pole displays, OEM printers, and all other point of sale equipment.

Wireless POS is a component of wireless telemetry, or machine-to-machine correspondence. Specifically, wireless POS is the ability to make a purchase using a credit/debit card in businesses that would use a wireless POS terminal, such as taxicabs, limos, home repair services (e.g. carpet cleaners or refrigerator repair), restaurants, or mobile merchants.

Many people make it a habit to collect credit card receipts throughout their monthly billing period and then compare those receipts with the actual billing statement from the credit card company. This act of reconciling charge receipts with a billing statement is a time consuming task. There may be many receipts that must be saved during a month, and many times some of these receipts are lost.

Thus, there is a need in the art for an improved method of reconciling credit card receipts with billing statements that is more accurate and less time consuming.

### SUMMARY

The invention in one implementation encompasses an apparatus. The apparatus comprises a telecommunications network having at least a receipt database; a mobile terminal having predetermined wireless communication functionality, the mobile terminal operative coupled to the telecommunications network; and a point of sale terminal wirelessly connectable to the mobile terminal.

The invention in a further implementation encompasses a method. The method comprises generating a receipt from a credit purchase at a point of sale terminal; wirelessly sending the receipt from the point of sale terminal to a mobile terminal; and storing the receipt in the mobile terminal.

Another implementation of the invention encompasses a method. The method comprises: subscribing to a credit receipt feature in a telecommunication network; defining a credit card list and storing the credit card list in the telecommunication network; generating a receipt from a credit card purchase at a point of sale terminal; wirelessly sending the receipt from the point of sale terminal to a mobile terminal; storing the receipt in the mobile terminal; uploading the receipt from the mobile terminal to the telecommunication network; and storing the receipt in the telecommunication network.

### DESCRIPTION OF THE DRAWINGS

Features of exemplary implementations of the invention will become apparent from the description, the claims, and the accompanying drawings in which:

FIG. 1 is a representation of one implementation of an apparatus that provides network support for reconciling credit card receipts;

FIG. 2 is a representation of one exemplary flow diagram for reconciling credit card receipts according to one implementation of the present method;

FIG. 3 is a representation of one exemplary flow diagram for reconciling credit card receipts according to another implementation of the present method;

FIG. 4 is a representation of a further exemplary flow diagram for reconciling credit card receipts according to an implementation of the present method; and

FIG. 5 is a representation of yet another exemplary flow diagram for reconciling credit card receipts according to an implementation of the present method.

### DETAILED DESCRIPTION

According to the present apparatus and method, mobile telecommunications networks and more specifically, a WiFi interface at the point of sale, are used to transmit a copy of a credit card transaction to a subscriber's mobile handset for reconciling credit card receipt transactions with a monthly billing statement from a credit card company.

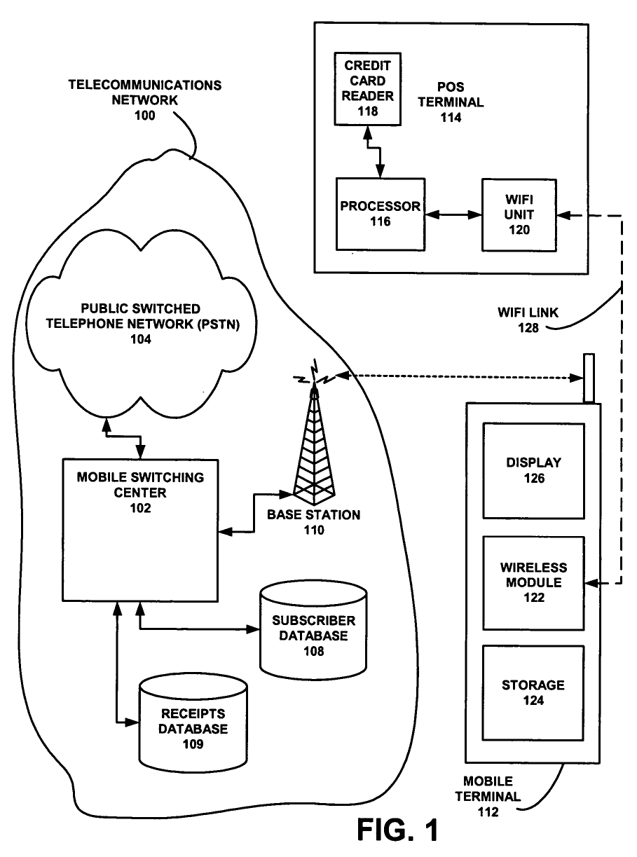

FIG. 1 is a representation of one implementation of an apparatus that provides network support for reconciling credit card receipts.

A telecommunications network 100 may have a mobile switching center (MSC) 102. The network 100 may be, or may be part of, one or more of a telephone network, a local area network (“LAN”), the Internet, and a wireless network. In the depicted embodiment, a public switched telephone network (PSTN) 104 may be connected to the MSC 102. The PSTN 104 routes calls to and from a mobile terminal 112 through the MSC 102. The MSC 102 may also be connected to at least one base station (BS) 110. The base station 110 communicates with the mobile terminal 112 in its service area using a subscriber database 108. The PSTN 104 generally may be implemented as the worldwide voice telephone network accessible to all those with telephones and access privileges (e.g., AT&T long distance network). The MSC may also have a receipts database 109.

The mobile terminal 112 may be any one of a number of devices, such as a cell phone, a personal data assistant (PDA), a laptop computer, etc. The mobile terminal 112 may have storage 124, such as a memory module, and may also have a wireless module 122, such as a WiFi component. Information may be depicted on a display 126.

Via a WiFi link 128 the mobile terminal 112 may be wirelessly operatively coupled to a point of sales terminal 114. The point of sales terminal 114 may also have a WiFi unit 120. A processor 116, or other software and/or hardware equipment, may interface with the WiFi unit 120 in order to transfer a receipt (such as a credit card transaction) from the point of sales terminal 114 to the mobile terminal 112. The receipt may be generated, for example, for a sale of merchandise that is charged to a credit card. A credit card reader 118 may read information from the credit card. When a receipt is generated from the credit card purchase at the point of sale terminal 114, a mobile number of the mobile terminal 112 is one of entered at the point of sale terminal or automatically retrieved with credit card account information.

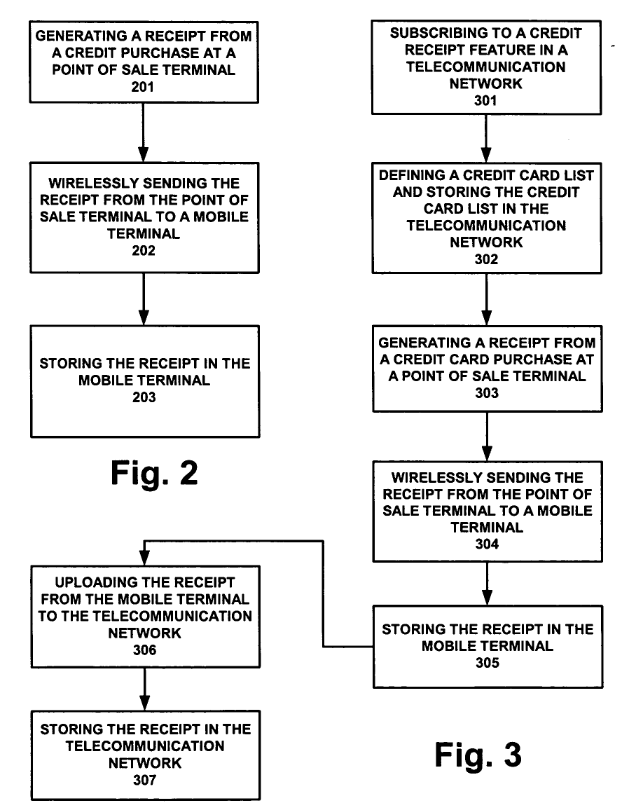

FIG. 2 is a representation of one exemplary flow diagram for reconciling credit card receipts. The method may have the steps of: generating a receipt from a credit purchase at a point of sale terminal (201); wirelessly sending the receipt from the point of sale terminal to a mobile terminal (202); and storing the receipt in the mobile terminal (203).

FIG. 3 is a representation of one exemplary flow diagram for reconciling credit card receipts. This method may have the steps of: subscribing to a credit receipt feature in a telecommunication network (301); defining a credit card list and storing the credit card list in the telecommunication network (302); generating a receipt from a credit card purchase at a point of sale terminal (303); wirelessly sending the receipt from the point of sale terminal to a mobile terminal (304); storing the receipt in the mobile terminal (305); uploading the receipt from the mobile terminal to the telecommunication network (306); and storing the receipt in the telecommunication network (307).

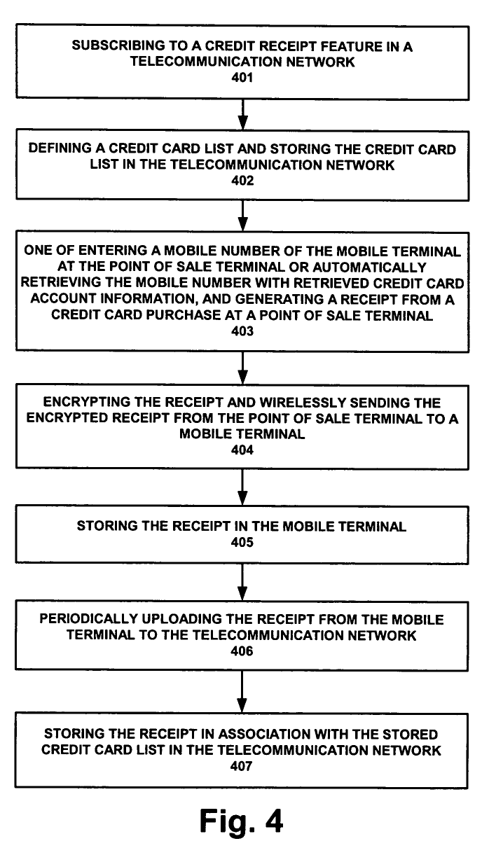

FIG. 4 is a representation of a further exemplary flow diagram for reconciling credit card receipts. This method may have the steps of: subscribing to a credit receipt feature in a telecommunication network (401); defining a credit card list and storing the credit card list in the telecommunication network (402); one of entering a mobile number of the mobile terminal at the point of sale terminal or automatically retrieving the mobile number with retrieved credit card account information, and generating a receipt from a credit card purchase at a point of sale terminal (403); encrypting the receipt and wirelessly sending the encrypted receipt from the point of sale terminal to a mobile terminal (404); storing the receipt in the mobile terminal (405); periodically uploading the receipt from the mobile terminal to the telecommunication network (406); and storing the receipt in association with the stored credit card list in the telecommunication network (407).

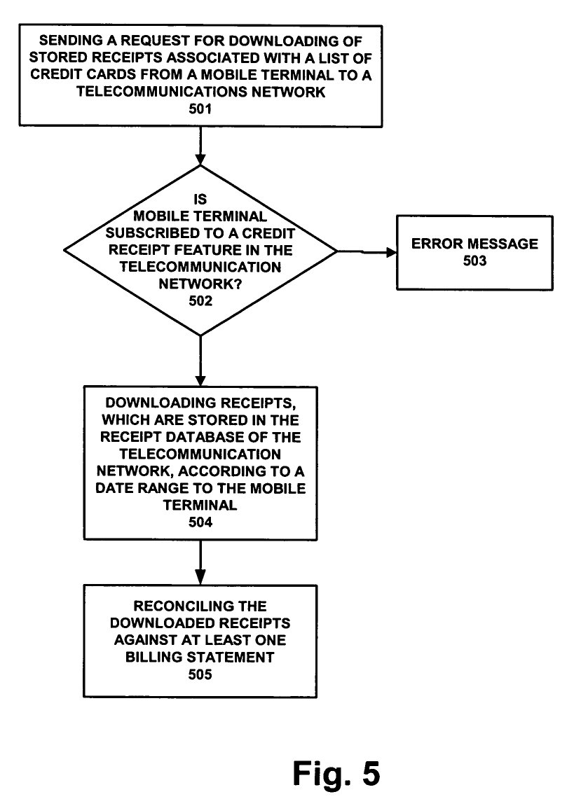

FIG. 5 is a representation of yet another exemplary flow diagram for reconciling credit card receipts. This method may have the steps of: sending a request for downloading of stored receipts associated with a list of credit cards from a mobile terminal to a telecommunications network (501); checking if the mobile terminal is subscribed to a credit receipt feature in the telecommunication network (502); providing an error message if the mobile terminal is not subscribed to the credit receipt feature (503); downloading receipts, if the mobile terminal is subscribed to the credit receipt feature, which are stored in the receipt database of the telecommunication network, according to a date range to the mobile terminal (504); and reconciling the downloaded receipts against at least one billing statement (505).

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. Examples of a computer-readable signal-bearing medium for the apparatus 100 may comprise the recordable data storage medium (subscriber database 108). The computer-readable signal-bearing medium for the apparatus 100 in one example may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory. In another example, the computer-readable signal-bearing medium may comprise a modulated carrier signal transmitted over a network comprising or coupled with the apparatus, for instance, one or more of a telephone network, a local area network (“LAN”), a wide area network (“WAN”), the Internet, and a wireless network.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
a telecommunications network having at least a receipt database;
a mobile terminal having predetermined wireless communication functionality, the mobile terminal operative coupled to the telecommunications network; and
a point of sale terminal wirelessly connectable to the mobile terminal.

2. The apparatus according to claim 1, wherein the mobile terminal is a cell phone, and wherein the wireless communication functionality is implemented by a WiFi module in the cell phone.

3. The apparatus according to claim 1, wherein the mobile terminal is a cell phone, and wherein the cell phone has a predetermined storage for storing receipts.

4. The apparatus according to claim 1, wherein at least one receipt is sent from the point of sale terminal to the mobile terminal where the at least one receipt is stored in a memory.

5. The apparatus according to claim 4, wherein the at least one receipt, which is stored in the memory of the mobile terminal, is uploaded to the telecommunication network and stored in the receipt database.

6. The apparatus according to claim 5, wherein the at least one receipt, which is stored in the receipt database of the telecommunication network, is downloaded to the mobile terminal.

7. The apparatus according to claim 1, wherein the telecommunications network has at least a mobile switching center operatively coupled to at least one base station, wherein the base station is wirelessly coupled to the mobile terminal, and wherein the mobile switching center is operatively coupled to the receipt database.

8. A method, comprising:
generating a receipt from a credit purchase at a point of sale terminal;
wirelessly sending the receipt from the point of sale terminal to a mobile terminal; and
storing the receipt in the mobile terminal.

9. The method according to claim 8, wherein the method further comprises uploading the receipt from the mobile terminal to a telecommunication network, and storing the receipt in the telecommunication network.

10. The method according to claim 9, wherein the method further comprises downloading the receipt from the telecommunication network to the mobile terminal.

11. The method according to claim 8, wherein the mobile terminal is a cell phone having predetermined wireless communication functionality, and wherein the wireless communication functionality is implemented by a WiFi module in the cell phone.

12. The method according to claim 8, wherein the mobile terminal is a cell phone, and wherein the cell phone has a predetermined storage for storing receipts.

13. The method according to claim 8, wherein at least one receipt is sent from the point of sale terminal to the mobile terminal where the at least one receipt is stored in a memory.

12. The method according to claim 13, wherein the at least one receipt, which is stored in the memory of the mobile terminal, is uploaded to the telecommunication network and stored in a receipt database in the telecommunication network.

13. The method according to claim 12, wherein the at least one receipt, which is stored in the receipt database of the telecommunication network, is downloaded to the mobile terminal.

14. A method, comprising:
subscribing to a credit receipt feature in a telecommunication network;
defining a credit card list and storing the credit card list in the telecommunication network;
generating a receipt from a credit card purchase at a point of sale terminal;
wirelessly sending the receipt from the point of sale terminal to a mobile terminal;
storing the receipt in the mobile terminal;
uploading the receipt from the mobile terminal to the telecommunication network; and
storing the receipt in the telecommunication network.

15. The method according to claim 14, wherein, when a receipt is generated from a credit card purchase at the point of sale terminal, a mobile number of the mobile terminal is one of entered at the point of sale terminal or automatically retrieved with credit card account information.

16. The method according to claim 14, wherein the receipt is encrypted before wirelessly sending the receipt from the point of sale terminal to a mobile terminal.

17. The method according to claim 14, wherein receipts are stored in the telecommunication network in association with the stored credit card list.

18. The method according to claim 14, wherein the receipts are periodically uploaded from the mobile terminal to the telecommunication network.

19. The method according to claim 14, wherein the receipts, which are stored in the receipt database of the telecommunication network, are downloaded according to a date range to the mobile terminal.

20. The method according to claim 14, wherein the mobile terminal is wirelessly coupled to the point of sale terminal via a WiFi communication link.
